(19) United States
(12) Patent Application Publication
(10) Pub. No.: US 2014/0109933 A1
(43) Pub. Date: Apr. 24, 2014

(54) CLEANING DEVICE OF MAGNETIC NANOPARTICLES AND CLEANING METHOD USING THE SAME

(71) Applicant: Samsung Electro-Mechanics Co., Ltd., Gyeonggi-do (KR)

(72) Inventors: Jung Wook Seo, Gyeonggi-do (KR); Tae Ho Kim, Gyeonggi-do (KR); Young Ku Lyu, Gyeonggi-do (KR); Kwang Myung Kim, Gyeonggi-do (KR); Kwan Lee, Gyeonggi-do (KR); Dong Hoon Kim, Gyeonggi-do (KR)

(73) Assignee: SAMSUNG ELECTRO-MECHANICS CO., LTD., Gyeonggi-do (KR)

(21) Appl. No.: 13/956,297

(22) Filed: Jul. 31, 2013

(30) Foreign Application Priority Data
Oct. 18, 2012 (KR) 10-2012-0115912

(51) Int. Cl. B08B 7/04; B03C 1/02; B08B 3/12

(52) U.S. Cl. CPC B08B 7/04; B08B 3/12; B03C 1/02
USPC 134/10; 134/109

(57) ABSTRACT

Disclosed herein are a cleaning apparatus of magnetic nanoparticles and a cleaning method of magnetic nanoparticles using the same. The cleaning apparatus of magnetic nanoparticles includes: a cleaning bath into which a solvent and magnetic nanoparticles are fed; a magnet member that is formed at a lower portion of the cleaning bath to separate the magnetic nanoparticles; and a discharge means that discharges the solvent from which the magnetic nanoparticles are separated.

### CROSS REFERENCE(S) TO RELATED APPLICATIONS

This application claims the benefit under 35 U.S.C. Section 119 of Korean Patent Application Serial No. 10-2012-0115912 entitled “Cleaning Device of Magnetic Nanoparticles and Cleaning Method Using the Same” filed on Oct. 18, 2012, which is hereby incorporated by reference in its entirety into this application.

### BACKGROUND OF THE INVENTION

1. Technical Field

The present invention relates to a cleaning device of magnetic nanoparticles and a cleaning method of magnetic nanoparticles using the same, and more particularly, to a cleaning device of magnetic nanoparticles capable of separating magnetic nanoparticles included in a solution to clean the magnetic nanoparticles and a cleaning method of magnetic nanoparticles using the same.

2. Description of the Related Art

Generally, as a method of manufacturing magnetic nanoparticles, there are a chemical synthesis method, a mechanical manufacturing method, and an electrical manufacturing method.

Here, the mechanical manufacturing method of crushing nanoparticles using a mechanical force is difficult to synthesize high-purity particles due to an injection of impurities during a process and is impossible to uniformly form particles having a nanosize.

Further, the electrical manufacturing method using electrolysis has disadvantages in that manufacturing time is long, concentration is low, and efficiency is low.

Further, the chemical synthesis method is largely classified into a vapor phase method and a colloid method. In the vapor phase method using plasma or a gas evaporation method, expensive facility is required. Therefore, a colloid method that can uniformly synthesize particles at low cost has been mainly used.

As the manufacturing method of magnetic nanoparticles using the colloid method, a method of manufacturing magnetic nanoparticles having a hydrosol type by dissociating metal compounds in a water system and then, using a reducing agent or a surfactant has been used.

As described above, a process of separating and recovering the synthesized magnetic nanoparticles into a solvent and the magnetic nanoparticles by centrifugation, putting and mixing the recovered magnetic nanoparticles in a cleaning facility, together with a cleaning solvent, and separating and recovering the cleaning solvent and the magnetic nanoparticles using a centrifugal separator is repeated to remove impurities on the surface of the magnetic nanoparticles.

However, in the case of the method according to the related art, a cleaning bath for cleaning magnetic nanoparticles and a centrifugal separator are separately configured and when a revolution rpm of the centrifugal separator is increased, the magnetic nanoparticles are aggregated, such that it is difficult to remove impurities on the surface of the magnetic nanoparticles during the cleaning process.

Further, the parts of magnetic nanoparticles with small size are not recovered during the centrifugation process and it is impossible to continuously perform the process due to the structure of the centrifugal separator.

### SUMMARY OF THE INVENTION

An object of the present invention is to provide a cleaning apparatus of magnetic nanoparticles capable of separating a solvent and a magnetic nanoparticles using a single apparatus, reducing the number of processes for cleaning magnetic nanoparticles, and effectively removing impurities on a surface of the magnetic nanoparticles and a cleaning method of magnetic nanoparticles using the same.

According to an exemplary embodiment of the present invention, there is provided a cleaning apparatus of magnetic nanoparticles, including: a cleaning bath into which a solvent and magnetic nanoparticles are fed; a magnet member that is formed at a lower portion of the cleaning bath to separate the magnetic nanoparticles; and a discharge means that discharges the solvent from which the magnetic nanoparticles are separated.

The cleaning apparatus of magnetic nanoparticles may further include: an agitator that agitates the solvent and the magnetic nanoparticles fed into the cleaning bath.

The cleaning apparatus of magnetic nanoparticles may further include: an ultrasonic generator that is formed at one side of the cleaning bath.

A lower portion of the cleaning bath may be inclined to one side.

A lower portion of the cleaning bath may be inclined in a funnel form.

The magnet member may be formed of a permanent magnet or an electromagnet.

The discharge means may include: a discharge pipe through which the solvent is discharged; a pump that is connected with one end of the discharge pipe; and a filter that is formed at the other end of the discharge pipe and is dipped in the cleaning bath.

The discharge pipe may be formed so that a height of the discharge pipe dipped in the cleaning bath is controlled according to the amount of solvent and magnetic nanoparticles in the cleaning bath.

According to another exemplary embodiment of the present invention, there is provided a cleaning method of magnetic nanoparticles, including: feeding a solution including magnetic nanoparticles into a cleaning bath having a magnet member formed at a lower portion thereof; recovering the magnetic nanoparticles from the solution fed into the cleaning bath; cleaning the magnetic nanoparticles by feeding a cleaning solvent into the cleaning bath; and recovering the cleaned magnetic nanoparticles.

After the recovering of the cleaned magnetic nanoparticles, the cleaning of the magnetic nanoparticles by changing the cleaning solvent and the recovering of the cleaned magnetic nanoparticles may be repeated.

The recovering of the magnetic nanoparticles from the solution may include: separating the magnetic nanoparticles by applying magnetic field to the magnet member; and discharging the solvent from which the magnetic nanoparticles are separated.

The cleaning of the magnetic nanoparticles may include: feeding a cleaning solvent into the cleaning bath and removing magnetic field applied to the magnetic nanoparticles; agitating the cleaning solvent and the magnetic nanoparticles; and applying ultrasonic waves to the magnetic nanoparticles.

The recovering of the cleaned magnetic nanoparticles may include: separating the magnetic nanoparticles by applying magnetic field to the magnet member; and discharging the cleaning solvent from which the magnetic nanoparticles are separated.

### BRIEF DESCRIPTION OF THE DRAWINGS

FIG. 1 is a schematic diagram a cleaning apparatus of magnetic nanoparticles according to an exemplary embodiment of the present invention.

FIGS. 2 and 3, are schematic diagrams of another form of a cleaning bath of FIG. 1.

FIG. 4 is a flow chart illustrating a cleaning process of magnetic nanoparticles according to the exemplary embodiment of the present invention.

### DESCRIPTION OF THE PREFERRED EMBODIMENTS

Hereinafter, exemplary embodiments of the present invention will be described in detail with reference to the accompanying drawings. However, this is only by way of example and therefore, the present invention is not limited thereto.

When technical configurations known in the related art are considered to make the contents obscure in the present invention, the detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

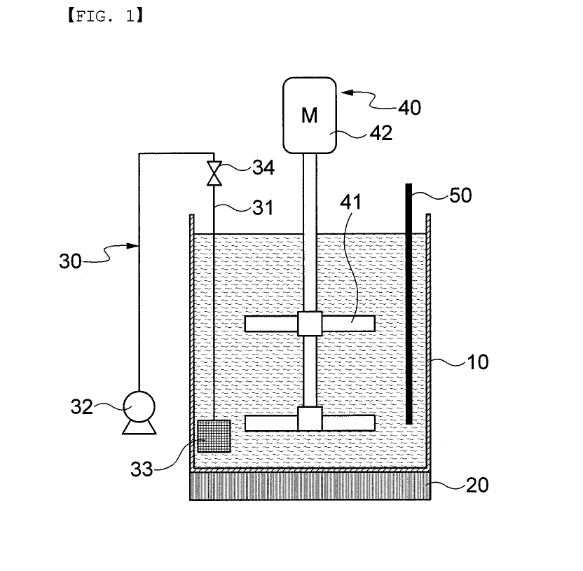

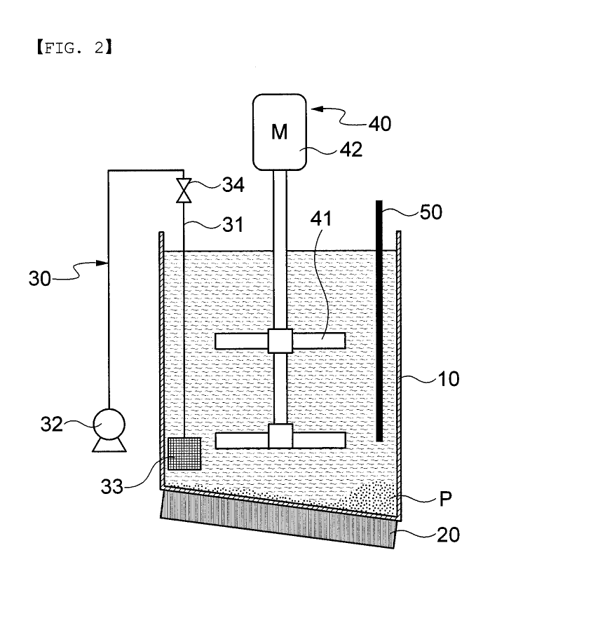

FIG. 1 is a schematic diagram a cleaning apparatus of magnetic nanoparticles according to an exemplary embodiment of the present invention and FIGS. 2 and 3 are schematic diagrams of another form of a cleaning bath of FIG. 1.

As illustrated in FIGS. 1 to 3, a cleaning apparatus of magnetic nanoparticles according to an exemplary embodiment of the present invention includes a cleaning bath 10, a magnet member 20, and a discharge means 30.

The cleaning bath 10 is filled with a solution in which a solvent and magnetic nanoparticles P are mixed and an upper portion thereof may be opened. The recovery of the magnetic nanoparticles P and the process of cleaning the magnetic nanoparticles P through mixing with cleaning solvent are performed in the cleaning bath 10.

The magnet member 20 separates the solvent and the magnetic nanoparticles P that are fed into the cleaning bath 10 and may be formed at a lower portion of the cleaning bath 10.

Here, the magnet member 20 may be formed of any one selected from a permanent magnet having magnetism at all times and an electromagnet having magnetism when current is applied thereto.

In this case, when the magnet member 20 is formed of the permanent magnet, the magnet member 20 is detachably formed on a lower surface of the cleaning bath 10 and therefore, is attached to the cleaning bath 10 only at the time of separating the magnetic nanoparticles P, such that the magnetic field may be applied to the inside of the cleaning bath 10.

Further, when the magnet member 20 is formed of the electromagnet, the magnetic field may be applied to the inside of the cleaning bath 10 by supplying current to the magnet member 20 only at the time of separating the magnetic nanoparticles P.

That is, when the magnetic field is applied to the cleaning bath 10 by the magnet member 20, the magnetic nanoparticles P by the magnetic field in the cleaning bath 10 filled in cleaning solution is concentrated on the lower portion of the cleaning bath 10 and therefore, is separated from the solvent.

Here, when the magnetic nanoparticles P are concentrated on the lower portion of the cleaning bath 10 and therefore, is separated from the solvent, the solvent is discharged through the discharge means 30.

The discharge means 30 may include a discharge pipe 31 through which the solvent is discharged, a pump 32 connected with one end of the discharge pipe 31, and a filter 33 formed at the other end of the discharge pipe 31 and dipped in the cleaning bath 10.

Here, the discharge pipe 31 having one end connected with the pump 32 to discharge the solvent may be formed to discharge a solvent through the opened upper portion of the cleaning bath 10 and may be formed to control a height of the discharge pipe 31 dipped in the cleaning bath 10 according to the amount of solvent and magnetic nanoparticles p that are filled in the cleaning bath 10.

That is, when the magnetic nanoparticles P are concentrated on the lower portion of the cleaning bath 10, the height of the discharge pipe 31 dipped in the cleaning bath 10 is controlled at the time of discharging the solvent to prevent the magnetic nanoparticles P from being discharged together with the solvent.

Further, end of the discharge pipe 31 dipped in the cleaning bath 10 is provided with the filter 33 to filter the magnetic nanoparticles P, thereby preventing the magnetic nanoparticles P from being discharged together with the solvent.

Further, one side of the discharge pipe 32 may be provided with the valve 34 to control the discharged amount of solvent.

Meanwhile, at the time of cleaning the magnetic nanoparticles P, an agitator 40 that agitates the cleaning solvent and the magnetic nanoparticles P fed into the cleaning bath 10 may be further provided.

The agitator 40 is formed so that at least one agitating wing 41 is dipped in the cleaning bath 10 and may be configured of a motor 42 that rotates a rotating shaft provided with the agitating wing 41.

That is, the agitator 40 agitates the cleaning solvent and the magnetic nanoparticles P that are fed into the cleaning bath 10 at the time of cleaning the magnetic nanoparticles P to remove the impurities on the surface of the magnetic nanoparticles P.

Further, one side of the cleaning bath 10 may be equipped with an ultrasonic generator 50 that generates the ultrasonic waves.

Here, the ultrasonic generator 50 may be formed so as to be dipped in the cleaning bath 10 and the ultrasonic waves generated from the ultrasonic generator 50 are irradiated to the magnetic nanoparticles, thereby effectively removing impurities on the surface of the magnetic nanoparticles P.

FIGS. 2 and 3 are schematic diagrams of another form of the cleaning bath of FIG. 1.

As illustrated in FIG. 2, the lower surface of the cleaning bath 10 may be inclined to one side.

Here, the lower surface of the cleaning bath 10 may be provided with the magnet member 20 and the magnetic nanoparticles P concentrated by the magnet member 20 moves along the inclined surface so as to be concentrated on one side.

Further, as illustrated in FIG. 3, the lower surface of the cleaning bath 10 may be inclined in a funnel form.

In this case, the inclined surface of the lower surface of the cleaning bath 10 may be provided with the magnet member 20 and the magnetic nanoparticles P concentrated by the magnet member 20 moves along the inclined surface so as to be concentrated on a central area.

That is, when the lower surface of the cleaning bath 10 is inclined, the magnetic nanoparticles P are concentrated on the lower portion of the inclined surface, such that at the time of recovering the magnetic nanoparticles P, the magnetic nanoparticles P may be smoothly concentrated without the loss of the magnetic nanoparticles P.

Hereinafter, the cleaning method of magnetic nanoparticles according to the exemplary embodiment of the present invention will be described with reference to FIG. 3.

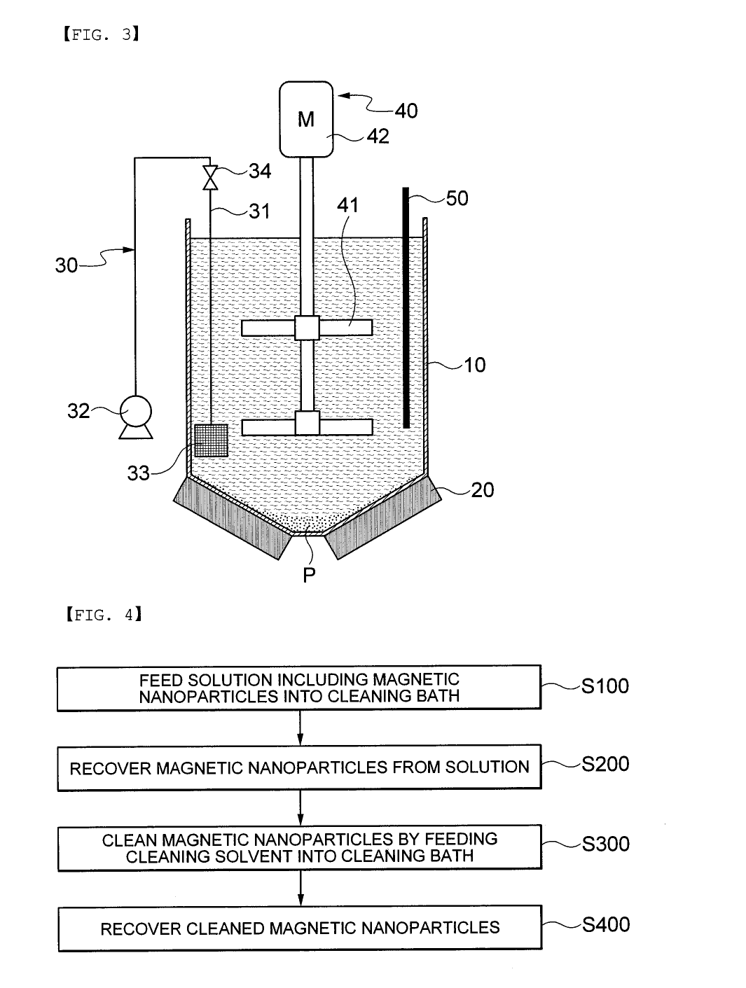

FIG. 4 is a flow chart illustrating a cleaning process of magnetic nanoparticles according to the exemplary embodiment of the present invention.

As illustrated in FIG. 4, the cleaning method of magnetic nanoparticles according to the exemplary embodiment of the present invention includes feeding a solution including magnetic nanoparticles P into a cleaning bath 10 having a magnet member 20 formed at a lower portion thereof (S100), recovering the magnetic nanoparticles P from the solution fed into the cleaning bath 10 (S200), cleaning the magnetic nanoparticles P by feeding a cleaning solvent into the cleaning bath 10 (S300), and recovering the cleaned magnetic nanoparticles P (S400).

First, the feeding into the solution including the magnetic nanoparticles P into the cleaning bath 10 provided with the magnet member 20 may be performed.

Here, the solution fed into the cleaning bath 10 is a solution including the magnetic nanoparticles P and therefore, the solution obtained by performing the synthesis process on the magnetic nanoparticles P may be fed into the cleaning bath 10.

Next, the recovering of the magnetic nanoparticles P from the solution fed into the cleaning bath 10 (S200) may be performed.

In the recovering of the magnetic nanoparticles P (S200), a magnetic field is applied to the cleaning bath 10 by the magnet member 20 formed at the lower portion of the cleaning bath 10 to concentrate the magnetic nanoparticles P on the lower portion of the cleaning bath 10, thereby separating the magnetic nanoparticles P from the solvent.

Meanwhile, the magnet member 20 applying the magnetic field may be formed of any one of a permanent magnet having magnetism at all times or an electromagnetic magnet having magnetism when current is applied thereto.

In this case, when the magnet member 20 is formed of a permanent magnet, the magnet member 20 is attached to the lower surface of the cleaning bath 10 to apply the magnetic field, thereby separating the magnetic nanoparticles P. Further, when the magnet member 20 is formed of an electromagnet, the magnet member 20 is applied with current in the state in which the magnet member 20 is attached to the lower surface of the cleaning bath 10 to apply the magnetic field, thereby separating the magnetic nanoparticles P.

Next, the solvent from which the magnetic nanoparticles P are separated is discharged to the outside of the cleaning bath 10 by the discharge means 30.

Here, the discharge means 30 is configured to include the discharge pipe 31, the pump 32, and the filter 33, wherein one end of the discharge pipe 31 provided with the filter 33 is dipped in the cleaning bath 10 and the pump 32 connected with the discharge pipe 31 is driven to discharge the solvent through the opened upper portion of the cleaning bath 10, thereby recovering the magnetic nanoparticles P.

In this case, the height of the discharge pipe 31 dipped in the cleaning bath 10 can be controlled according to the amount of solvent and magnetic nanoparticles P.

Next, the cleaning of the magnetic nanoparticles P by feeding the cleaning solvent into the cleaning bath 10 (S300) may be performed.

In the cleaning of the magnetic nanoparticles P (S300), the cleaning solvent may first be fed into the cleaning bath 10. In this case, as the cleaning solvent, ethanol, acetone, toluene, and methanol may be used.

Next, after the cleaning solvent is fed, the magnetic field applied through the magnet member 20 is removed and the agitator 40 is driven to agitate the cleaning solvent and the magnetic nanoparticles P, thereby cleaning the magnetic nanoparticles P. In this case, the cleaning efficiency of the magnetic nanoparticles P can be increased by applying the ultrasonic waves generated from the ultrasonic generator 50 formed at one side of the cleaning part 10.

Next, the recovering of the cleaned magnetic nanoparticles P (S400) may be performed.

Here, in the recovering of the cleaned magnetic nanoparticles P (S400), a magnetic field is applied to the cleaning bath 10 by the magnet member 20 formed at the lower portion of the cleaning bath 10 to concentrate the magnetic nanoparticles P on the lower portion of the cleaning bath 10, thereby separating the magnetic nanoparticles P from the cleaning solvent. Next, the magnetic nanoparticles P can be recovered by discharging the cleaning solvent from which the magnetic nanoparticles P are separated to the outside of the cleaning bath 10 by the discharge means 30.

Next, the magnetic nanoparticles P can be cleaned by repeating the cleaning of the magnetic nanoparticles P by changing the cleaning solvent and feeding the changed cleaning solvent into the cleaning bath (S300) and the recovering of the cleaned magnetic nanoparticles P (S400).

Therefore, according to the cleaning apparatus of magnetic nanoparticles and the cleaning method of magnetic nanoparticles using the same according to the exemplary embodiment of the present invention, the solvent is separated from the magnetic nanoparticles P by the magnet member 20 and the solvent is discharged by the discharge means 30 to perform the recovery and cleaning of the magnetic nanoparticles P in the single cleaning bath 10, thereby removing the necessity of the separate facility for recovery and cleaning to reduce the facility space and the facility investment and reducing the number of processes moving facilities for clean and recover the magnetic nanoparticles P to shorten the lead time and increase the manufacturing yield.

Further, the cleaning efficiency of the magnetic nanoparticles P can be increased by agitating the cleaning solvent and the magnetic nanoparticles P by the agitator 40 and cleaning the magnetic nanoparticles P using the ultrasonic waves generated from the ultrasonic generator 50.

As set forth above, according to the cleaning apparatus of magnetic nanoparticles and the cleaning method of magnetic nanoparticles using the same of the exemplary embodiments of the present invention, it is possible to perform both of the separation and cleaning of the magnetic nanoparticles in the cleaning bath synthesizing the magnetic nanoparticles, thereby removing the necessity of the separate facility for separation and cleaning to reduce the facility space and the facility investment and reducing the number of manufacturing processes to shorten the lead time and increase the manufacturing yield.

Further, it is possible to agitate the cleaning solvent and the magnetic nanoparticles by the agitator and clean the magnetic nanoparticles using ultrasonic waves generated from the ultrasonic generator, thereby increasing the cleaning efficiency of the magnetic nanoparticles.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. A cleaning apparatus of magnetic nanoparticles, comprising:
a cleaning bath into which a solvent and magnetic nanoparticles are fed;
a magnet member that is formed at a lower portion of the cleaning bath to separate the magnetic nanoparticles; and
a discharge means that discharges the solvent from which the magnetic nanoparticles are separated.

2. The cleaning apparatus of magnetic nanoparticles according to claim 1, further comprising:
an agitator that agitates the solvent and the magnetic nanoparticles fed into the cleaning bath.

3. The cleaning apparatus of magnetic nanoparticles according to claim 1, further comprising:
an ultrasonic generator that is formed at one side of the cleaning bath.

4. The cleaning apparatus of magnetic nanoparticles according to claim 1, wherein a lower portion of the cleaning bath is inclined to one side.

5. The cleaning apparatus of magnetic nanoparticles according to claim 1, wherein a lower portion of the cleaning bath is inclined in a funnel form.

6. The cleaning apparatus of magnetic nanoparticles according to claim 1, wherein the magnet member is formed of a permanent magnet or an electromagnet.

7. The cleaning apparatus of magnetic nanoparticles according to claim 1, wherein the discharge means includes:
a discharge pipe through which the solvent is discharged;
a pump that is connected with one end of the discharge pipe; and
a filter that is formed at the other end of the discharge pipe and is dipped in the cleaning bath.

8. The cleaning apparatus of magnetic nanoparticles according to claim 7, wherein the discharge pipe is formed so that a height of the discharge pipe dipped in the cleaning bath is controlled according to the amount of solvent and magnetic nanoparticles in the cleaning bath.

9. A cleaning method of magnetic nanoparticles, comprising:
feeding a solution including magnetic nanoparticles into a cleaning bath having a magnet member formed at a lower portion thereof;
recovering the magnetic nanoparticles from the solution fed into the cleaning bath;
cleaning the magnetic nanoparticles by feeding a cleaning solvent into the cleaning bath; and
recovering the cleaned magnetic nanoparticles.

10. The cleaning method of magnetic nanoparticles according to claim 9, wherein after the recovering of the cleaned magnetic nanoparticles, the cleaning of the magnetic nanoparticles by changing the cleaning solvent and the recovering of the cleaned magnetic nanoparticles are repeated.

11. The cleaning method of magnetic nanoparticles according to claim 9, wherein the recovering of the magnetic nanoparticles from the solution includes:
separating the magnetic nanoparticles by applying magnetic field to the magnet member; and
discharging the solvent from which the magnetic nanoparticles are separated.

12. The cleaning method of magnetic nanoparticles according to claim 9, wherein the cleaning of the magnetic nanoparticles includes:
feeding a cleaning solvent into the cleaning bath and removing magnetic field applied to the magnetic nanoparticles;
agitating the cleaning solvent and the magnetic nanoparticles; and
applying ultrasonic waves to the magnetic nanoparticles.

13. The cleaning method of magnetic nanoparticles according to claim 9, wherein the recovering of the cleaned magnetic nanoparticles includes:
separating the magnetic nanoparticles by applying magnetic field to the magnet member; and
discharging the cleaning solvent from which the magnetic nanoparticles are separated.
